(19) United States
(12) Patent Application Publication
(10) Pub. No.: US 2010/0260820 A1
(43) Pub. Date: Oct. 14, 2010

(54) PLASTER FOR PLANTS WITH AN EXPANDED MATRIX

(76) Inventors: Malgorzata Kloczko, Neustadt/Wied (DE); Peter Kreucher, Bad Breisig (DE)

Correspondence Address: FROMMER LAWRENCE & HAUG, 745 FIFTH AVENUE- 10TH FL., NEW YORK, NY, 10151, US

(21) Appl. No.: 12/740,737

(22) PCT Filed: Oct. 30, 2008
(86) PCT No.: PCT/EP2008/009144

§ 371 Date: Apr. 30, 2010

(30) Foreign Application Priority Data
Nov. 2, 2007 (DE) 10 2007 052 339.6

(51) Int. Cl. A01N 25/34; A01N 57/12; A01N 43/40; A01N 25/12; A01P 7/04

(52) U.S. Cl. 424/443; 514/119; 514/357; 424/486

(57) ABSTRACT

The invention relates to a plaster for applying systemic active substances to plants, the matrix thereof, that contains the active substance, is expanded and consists of in particular, a hot melt adhesive containing the active substance. Said plaster, based on its flexibility and adhesiveness, is suitable for applying active substances to the trunk or branches of trees.

The present invention relates to a device, preferably in the form of a patch, for administering systemic active substances for the treatment of plants, in particular of trees. The patch is distinguished by an active-substance-comprising matrix with a foam-like structure.

Patches for administering systemic active substances to plants are known.

Thus, EP 0 254 196 B1 discloses a device for the transcuticular application of active substances to plants and a method of treating plants with fungicidal, herbicidal, insecticidal and/or acaricidal active substances. The device takes the form of an active substance support which stores the active substance, the surface of the active substance support being designed as a contact layer for the plant surface, by which layer the active substance is delivered to the plant. The device can additionally feature a self-adhesive layer and a contact area of up to 20 cm².

EP 0 734 650 B1 discloses patch preparations for treating plants, which preparations feature a layer of an agrochemically active substance, at least one adhesive and, if appropriate, one or more additives, in which layer these substances are dispersed in a solid matrix.

These plant patches contain the active substance in a relatively inflexible polymer matrix (for example PVC, polypropylene or polybutadiene), which limits the usability of these patches to application to level surfaces such as, for example, the surfaces of leaves, or to still smooth, green stems of vegetable plants.

DE 39 22 366 A1 discloses a device consisting of a backing layer and an active substance support, which acts as the contact layer to the plant surface, for delivering systemic active substances to plants. The device has a moldable storage compartment for the active substance which molds itself to an uneven surfaces and which makes possible the delivery of the active substances across surfaces of plants which are composed of secondary and hardened epidermal tissues and which are not covered by a cuticle.

All the devices mentioned are capable of improvement, in particular in the light of their usefulness for trunks or branches of plants, in particular on old trees, which have a relatively large diameter and circumference and which tend to develop deep fissures in the bark. Since this situation requires the use of devices with preferably relatively large active-substance-comprising contact areas, i.e. relatively large patches, this capability of improvement applies to the adhesion properties and to the plasticity and thus moldability of the patch so that the latter is also suitable for use on trunks or branches with highly irregular surfaces composed of secondary epidermal tissue, such as cortex, cork or bark. There is a very particular need in trees where the outermost layer (the cork) does not become detached, but builds up and leads to the development of a hoop bark (for example in the case of Thuja plicata), a rhytidome (Acer pseudoplatanus, Aesculus hippocastanum) or a reticulate bark (for example Quercus petraea).

It was therefore an object of the present invention to provide a device which is suitable in particular for the delivery of systemic active substances to trunks and branches of plants with a secondary epidermal tissue while avoiding the disadvantages of the prior art. In particular, the device should have good adhesion properties and high elasticity so that it can also be fastened securely to lignified, highly uneven surfaces, including relatively large surfaces.

This object is achieved by providing the device according to the invention for applying active substances to plants, preferably in the form of a patch, which device is characterized in that it features an expanded active-substance-comprising matrix. The active-substance-comprising matrix takes the form of an active-substance-comprising composition of at least one polymer and/or elastomer, preferably an active-substance-comprising adhesive composition and especially preferably an active-substance-comprising hot-melt adhesive.

The patch according to the invention corresponds to a plant or tree patch. It can be brought into intimate contact with the plant so that the systemic active substance present in the matrix enters the plant via the trunk, the branches, leaves or stems and is distributed within the plant's vascular bundle system.

The patch contains a backing layer, an active-substance-comprising matrix and a peelable protective layer which protects the active-substance-comprising matrix for storage and transport. An adhering, adhesive-comprising covering layer may additionally be located between this protective layer and the matrix. In the case of the patches according to the invention, however, this covering layer can preferably be dispensed with when the matrix is self-adhesive. A backing layer, too, can be dispensable in particular when the active substance present in the matrix is particularly resistant to water or weathering, or when the patch is not used in the open.

The backing layer, which is preferably impervious to the active substance, terminates the construction of the patch on the side facing away from the plant. Materials which are suitable for forming the backing layer are polymers (such as, for example, polyethylene terephthalate (PET), polyvinyl chloride (PVC) or polystyrene (PS)), paper, thin metal foils (for example made of aluminum) or composite materials of the abovementioned materials. The backing layer may be colored so that the patch is clearly visible on the plant.

In a further embodiment, the backing layer can be designed in such a way, for example by means of a metal or textile insert, that it acts as a support layer for stabilizing the laminate. In a particular embodiment, the area of the backing layer is greater than that of the following active-substance-comprising matrix and is coated, on its underside, with a pressure-sensitive adhesive. Thereby, it simultaneously acts to attach the active-substance-comprising matrix to the plant. In this embodiment, a further separate adhesive layer may also be dispensed with.

The matrix comprising the active substance, which matrix acts as storage compartment, or support, for the active substance, may consist of one layer or a plurality of layers, it not being necessary for all layers to comprise an active substance. A matrix composed of a plurality of layers may comprise different active substances (for example two separate active substances in two separate layers) and can thus form a reservoir of an active substance combination.

The one matrix layer, or plurality of matrix layers, may additionally comprise means which accelerate or delay the release of the active substance. Suitable release accelerators include butyrolactone, N-methylpyrrolidone (NMP) and N-octylpyrrolidone (NOP).

The matrix material is preferably composed of at least one polymer or elastomer, which may have for example tackifiers added to them in order to arrive at a self-adhesive (i.e. pressure-sensitive adhesive) active-substance-comprising matrix. Also, the matrix may be composed of a self-adhesive, i.e. pressure-sensitive adhesive, polymer. Polymers with a suitable composition and glass transition temperature are known to the skilled worker.

It is especially preferred to employ adhesive compositions as the matrix material. Since the matrix material will now have self-adhesive (=“pressure-sensitive adhesive”) properties, the use of an additional adhesive layer in the patch can be dispensed with in such cases. Also, the protective film to be peeled off prior to use can be applied directly to the active-substance-comprising matrix in this case.

Adhesive compositions which can be employed advantageously are thermoplastic hot-melt pressure-sensitive adhesive compositions based on natural and synthetic latices (elastomers) and other synthetic polymers such as ethylene/vinyl acetate copolymers (preferably those with a VA content of between 20-65%), polyacrylates, polymethacrylates, polyurethanes, polyolefins, polyvinyl derivatives, polyesters or silicones with corresponding additives such as adhesive resins, plasticizers, stabilizers and other adjuvants, if required.

The polymers which are suitable also include hot-melt type adhesives, also known as hot melts. These are adhesive compositions which set physically and which are present, at room temperature, as a single component in solid, solvent-free form. A variety of polymers and copolymers are available as starting materials for hot-melt type adhesives, in particular a) polymers and copolymers such as ethylene/vinyl acetate, ethylene/CO copolymers, ethylene/vinyl acetate/CO terpolymers, ethylene/acrylate/CO terpolymers, propylene/hexene copolymers, polybutenes, SIS/SBS copolymers, thermoplastic elastomers and amorphous polyolefins, b) polyadducts such as linear thermoplastic polyurethanes and c) polycondensates such as copolyesters, polyamide resins, copolyamides, polyamide/EVA copolymers, polyamide/siloxane copolymers, polyester amides, polyetheresteramides, polyester amide/imines and polyether amides. Such hot-melt type adhesives are known to the skilled worker, for example from G. Habenicht: “Kleben”, 5th Ed., Springer Verlag, Berlin Heidelberg, (2005) p. 206-215. These hot-melt type adhesives are referred to in the present specification as “hot-melt adhesive”. They are pressure-sensitively adhesive at room temperature and hence differ from the heat seal compositions—which are not meant in this context—, which are nontacky at room temperature, liquefy upon heating and, upon cooling, form the bond while solidifying.

Their softening temperature should be higher than 50° C. since the “processing temperature” will generally be higher, preferably above 90° C. and especially preferably between 110° C. and 150° C. Preferably, the softening temperature is between 70-85° C. If appropriate, post-crosslinking by UV or electron-beam irradiation may be appropriate (in the present specification, “processing temperature” is understood as meaning the temperature at which the gas is introduced into the polymer or elastomer melt).

Especially preferred are hot-melt adhesives (also referred to as hot-melt self-adhesives or hot-melt pressure-sensitive adhesives (HMPSAs). These materials, which are based on block copolymers, have the advantage of having “pressure-sensitive adhesion properties” even at room temperature. They are distinguished by their wide range of possible uses, because the bonding required to meet the intended requirements is ensured even at critical points by the specific lowering of the glass transition temperature of the hot-melt adhesive as a result of the choice of tackifiers, plasticizers and the size of the polymer molecules and the molecular distribution of the components employed.

The high shear strength of the hot-melt adhesive is achieved by the high cohesion of the polymers. The good tack is the result of the range of tackifiers and plasticizers employed.

For systems with particularly pronounced adhesion properties, the hot-melt adhesive is preferably based on block copolymers, in particular A-B, A-B-A block copolymers or mixtures of these. The hard phase A is predominantly polystyrene or its derivatives, while the soft phase B comprises ethylene, propylene, butylene, butadiene, isoprene or mixtures of these, especially preferably ethylene and butylene or mixtures of these. However, polystyrene blocks may also be present in the soft phase B, namely up to 20% by weight. However, the total styrene content should always be lower than 35% by weight. Preferred are styrene contents of between 5% and 30% since a low styrene content makes the adhesive composition more clingy. Particularly advantageous is the customized mixing of di-block and tri-block copolymers, with a di-block copolymer content of less than 80% by weight being preferred. In an advantageous embodiment, the hot-melt adhesive has the composition specified hereinbelow:
10% by weight to 90% by weight of block copolymers,
5% by weight to 80% by weight of tackifiers,
less than 60% by weight of plasticizers,
less than 15% by weight of additives,
less than 5% by weight of stabilizers, and
0.5% by weight to 50% by weight of active substance or active substances, which completes the composition of the active-substance-comprising matrix.

The aliphatic or aromatic oils, waxes and resins which act as tackifiers are preferably liquid hydrocarbons, hydrocarbon waxes and hydrocarbon resins or mixtures of these. Medium- or long-chain fatty acids and/or esters of these are used as plasticizers. These additives serve to adjust the adhesive properties and the stability.

Moreover, further adjuvants and additives described in the prior art such as, for example, plasticizers, thickeners, swelling agents, penetration accelerators for the active substance, plasticizers, preservatives, disinfectants, pH regulators, antioxidants, stabilizers, crosslinking agents, fillers and/or foam stabilizers may be added to the matrix material. Such substances are described in particular in DE 39 22 366 A1 (for example column 4, line 47-column 6, line 40). This document is expressly referred to and incorporated as component of the present description. Further documents of the prior art in this context are the documents EP 0 254 196 B1 and EP 0 734 650 B1 cited at the outset, which are likewise expressly referred to for disclosure purposes.

Filling the adhesive composition with mineral fillers, fibers, hollow microspheres or solid microspheres is possible.

The hot-melt adhesive preferably has a softening point of below 50° C., preferably 70° C. to 220° C., but especially preferably 75° C. to 120° C.

The hot-melt adhesives are preferably designed such that they have a dynamic-complex glass transition temperature at a frequency of 0.1 rad/s of less than 10° C., preferably of 0° C. to −30° C., very especially preferably from −6° C. to −25° C. Since high demands are made of the patches according to the invention with regard to the adhesive properties, the hot-melt adhesive should have good tack properties so that it is simple to use.

The necessary bonding, to the plant and the reverse side of the support/backing layer, which must meet the intended requirement, is achieved by the targeted lowering of the glass transition temperature of the hot-melt adhesive as a result of the choice of the tackifiers, the plasticizers and the size of the polymer molecules and the molecular distribution of the components employed.

The patch according to the invention is characterized in that the matrix is expanded. This applies both to a matrix composed of the above-described elastomers and/or polymers and to the adhesive compositions preferred in accordance with the invention, in particular the hot-melt adhesives.

The generation of the foam structure will be illustrated in greater detail hereinbelow with reference to such a hot-melt adhesive. It can be applied to the other materials.

The active substances are preferably distributed in the adhesive composition in a heated stirred vessel or a heated homogenizer such as, for example, a heated kneader or a screw system. The active substance may be added once the preparation of the adhesive composition is complete. However, the active substance may also be incorporated into an intermediate stage or into the starting mixture.

The elastomers, polymers or adhesive compositions provided with the active substances are preferably expanded with inert gases such as nitrogen, carbon dioxide, noble gases, hydrocarbons or air, or mixtures of these. In some cases, additional expanding by thermal decomposition of gas-evolving substances such as azo, carbonate and hydrozide compounds has proved to be suitable.

The degree of expansion, i.e. the gas content of the matrix, should amount to at least approximately 5% by volume and may reach up to 85% by volume. In practice, values of between 10% by volume to 75% by volume, preferably up to 50% by volume, have proven to be useful. This property is controlled by the components which make up the composition or by technological parameters such as processing temperature or expansion properties of the gas. Adhesive compositions or hot-melt adhesives based on ethylene vinyl acetate are particularly suitable for achieving the preferred degrees of expansion.

These compositions are advantageously processed, i.e. softened and melted, at temperatures of between 50 and 80° C. A further decisive parameter for adjusting the degree of expansion is the pressure with which the conveyed active-substance-comprising adhesive composition counteracts the expanding gas.

The gas bubble size in the matrix with foam structure may vary from 0.05 mm to 3 mm (in diameter), depending on the processing temperature and the gas pressure. The range is advantageously between 0.2 and 1.5 mm, the range between 0.5 and 1 mm is especially preferred.

Due to the different bubble size, the bubble distribution is relatively inhomogeneous.

Since the expanded hot-melt adhesive cools without compression, the gas bubbles remain intact, which contributes to the formation of a stable foam (as opposed to a soft foam). Due to this property, the active-substance-comprising matrix also retains its expanded consistency over the entire application period of the patch. The expanded composition is advantageously cooled, which can be achieved by a cooled support or a cooled roller. Also, the use of a cooling tunnel through which the expanded composition is transported on its support has proved to be very expedient. A suitable cooling temperature is room temperature (20-22° C.) or temperatures below room temperature (0 to 20° C.). The use of an additional cooling tunnel is very advantageous in particular when the product takes the form of a roll.

The foam may have an open-cell, semi-open cell or else closed-cell microstructure. Open-cell structures are preferred since they can favor the release of volatile active substances from the patch.

The advantageous properties of the matrix according to the invention (expanded structure, pressure-sensitive adhesion property) consist in low adhesive consumption, high tack and good clinginess, even to uneven surfaces. Also, a certain degree of elasticity and a certain degree of plasticity of the expanded matrix can be exploited optimally in the field of active-substance patches.

A further advantage of the expanded structure is that the transportation of the active substances is increased drastically as a result of the vacuoles in the foam, whereby very good release rates can be achieved.

A particularly suitable method for preparing the expanded adhesive composition according to the invention operates by the foam-mix principle. Here, for example the thermoplastic adhesive composition is reacted with the intended gases such as, for example, nitrogen, air or carbon dioxide in various volume fractions (approximately 10% by volume to 80% by volume) in a stator/rotor system under high pressure at a temperature above the softening point (approximately 120° C.).

While the gas pre-pressure is greater than 100 bar, the mixing pressures of gas/thermoplast in the system amount to from 40 to 100 bar, preferably to from 40 to 70 bar. The “expanded adhesive composition” thus prepared can subsequently reach the applicator unit via a line. Commercially available nozzles, extruder systems or chamber systems (cf. in this context for example DE 197 49 467 A1) can be used in the applicator unit.

Further expanded thermoplastic adhesive compositions, and application methods and devices, which are suitable in accordance with the invention have been described for example in U.S. Pat. No. 4,059,714 and U.S. Pat. No. 4,200,207.

A method including device for the preparation and application of expanded thermoplastic hot-melt adhesives which is especially advantageous and especially suitable for the present invention is described in WO 2004/069424 A2. This method makes possible a careful application of the expanded, active-substance-comprising matrix material to a web-like support (for example to the backing film or separate support layer of the patch according to the invention), it being possible to generate application profiles with greater heights. This means that a thick and at the same time adaptable matrix layer can be prepared into which, naturally, even relatively high amounts of active substance (for patches with very long application periods, which are designed as slow-release formulations for single application) can be incorporated.

The patches according to the invention are suitable for the application of in principle all systemic active substances or active substance combinations which are employed in plant protection. Such active substances, for example viricidal, bactericidal, fungicidal, acaricidal and insecticidal active substances, are known to the skilled worker and described for example in the list of approved plant protection products in Germany, published by the Bundesamt für Verbraucherschutz and Lebensmittelsicherheit [German Federal Office for Consumer Protection and Food Safety].

These active substances include, in particular, abamectin, acequinocyl, acetamiprid, aclonifen, aluminum phosphide, amidosulfuron, azadirachtin (Neem), azoxystrobin, benzoic acid, beta-cyfluthrin, bifenthrin, boscalid, bromoxynil, bromuconazole, buprofezin, carfentrazone, chloridazon, chlorpyrifos, clofentezine, clothianidin, cyfluthrin, cymoxanil, cyproconazole, cyprodinil, deltamethrin, dicamba, dichlorvos, difenoconazole, diflubenzuron, dimethoate, dimethomorph, epoxiconazole, fenarimol, fenpropidin, flufenacet, fluquinconazole, fosetyl, glyphosate, imazalil, imidacloprid, iprodione, kresoxim-methyl, lambda-cyhalothrin, metconazole, penconazole, pirimicarb, propamocarb, pymetrozine, pyraclostrobin, pyrethrins, spinosad, tebuconazole, tebufenozide, tefluthrin, terbuthylazine, tetraconazole, thiabendazole, thiacloprid, thiamethoxam, thifensulfuron, thiophanate-methyl, tolylfluanid, trifloxystrobin, triticonazole and zeta-cypermethrin.

Especially preferred are: acetamiprid, clothianidin, difenoconazole, dimethoate, dimethomorph, epoxiconazole, fenpropidin, flufenacet, fluquinconazole, fosetyl, imazalil, imidacloprid, iprodion, kresoxim-methyl, lambda-cyhalothrin, metconazole, tetraconazole, thiabendazole, thiacloprid and thiamethoxam.

The active substance, or the active substances, are for example dissolved, dispersed, emulsified or distributed in microcapsules in the matrix composition.

The main feature which characterizes the plant protection patches according to the invention is the expanded active-substance-comprising matrix, whereby various advantages are obtained. Firstly, it imparts to the patches a very high degree of flexibility and moldability, i.e. it is also possible to prepare flexible patches with a very large matrix area.

Also, the patches are suitable for accommodating relatively large amounts of active substance, which allow long application periods.

Owing to its foam structure, the matrix, which is present as at least one layer, can be relatively thick. Such layer thicknesses may extend from 1 mm to 15 cm, with a thickness of from 3 mm to 2 cm being preferred.

The application quantity of active-substance-comprising matrix material (areal weight) is preferably between 50 g/m² and 1000 g/m², especially preferably between 350 g/m² and 700 g/m². Furthermore, the expanded matrix structure markedly increases the adhesiveness (tack) of a pressure-sensitive-finished active-substance-comprising matrix, whereby the spectrum of application of the patch is also widened.

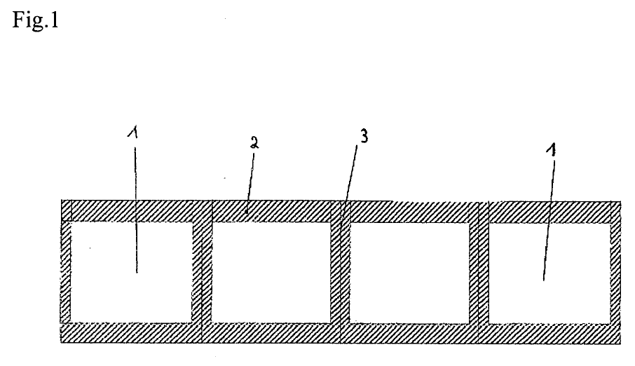

The active-substance-comprising matrix may be designed on one piece or feature a structure such as, for example, diamonds, cubes, with interposed matrix-free sections, whereby the flexibility of the patch can likewise be influenced. In a preferred embodiment (cf. FIG. 1), the patch can be produced as a continuous product with discrete matrix areas which are separated from one another. Tear lines may be provided between these matrix areas, whereby the user himself can generate a patch of the desired length which is specifically adapted to its use (for example as a tree patch to be applied to thick, lignified trunks).

The present invention therefore also relates to the use of the devices, or patches, according to the invention for the delivery of systemic active substances to plants, in particular to trees, via their trunks or branches (tree patch).

The invention is illustrated in greater detail by the examples which follow, without being limited thereto. The parameters specified in the examples are generic in nature and may be combined with one or more other features according to the invention which are mentioned in the description.

FIG. 1 shows a possible embodiment of the plant protection patch according to the invention. The sections with active-substance-comprising matrix (1) (area in each case 12.5 cm×10 cm with 2.5 g of active substance; application rate of active-substance-comprising expanded matrix material 690 g/m², degree of expansion 50-70% by volume, layer thickness 1.2 mm) are interrupted by matrix-free sections, i.e. for example the film support/backing layer (2) becomes visible here. The distance between the matrix sections in this specific case is, for example, 20 mm, and the width of the protruding film at the top and bottom edge (these sections may likewise be adhesive-finished) is, for example, 20 mm. Tear lines (for example perforations) (3) may be located between the matrix sections, whereby the user himself can prepare patches of any length. The overall size of the patch here is, for example, 58 cm×14 cm.

### EXAMPLE 1

An active-substance-comprising expanded matrix material (in total 750 g) in the form of a hot-melt adhesive is prepared from the following components:

| | | |
|---|---|---|
| Abitol ® E | 30.5% | by weight |
| Dertophene ® T105 | 19.5% | by weight |
| Evatane ® 40-45 | 15% | by weight |
| N-methylpyrrolidone | 5% | by weight |
| Dimethoate (active substance) | 30% | by weight |

The components are melted at no more than 85° C. in the order stated above and homogenized in a stirred thermocontainer.

In a melting apparatus, the prepared composition is heated to the required temperature, and heating is then continued. Using a suitable pump, in this case a gear pump, it is conveyed to the expansion unit. The core of the expansion unit is the mixing station. By means of a two-stage gear pump construction, it is not only possible, in the first stage, to meter the melted adhesive composition, but also, in the second stage, to mix the melted adhesive composition with the gas and then to homogenize the mixture. In a heated pressure tube, the foam thus generated is applied to the support material by means of a specifically designed application system. The application system is controlled via a line control system and is capable of coating both the entire area and intermittently. After coating, the web can be cooled to a temperature which allows further processing, in this case the preparation of roll stock.

The degree of expansion is between 50 and 70% by volume. The active-substance-comprising matrix foam is applied to a support, as shown in FIG. 1, with a layer thickness of approximately 1.2 mm. The application rate is 690 g/m². This gives rise to a patch with the dimensions 14 cm×58 cm and which is provided, on the as yet free matrix surface, with a peelable protective film. Owing to its size and moldability, this patch is outstandingly suitable as a tree patch.

### EXAMPLE 2

An active-substance-comprising expanded matrix material (in total 750 g) in the form of a hot-melt adhesive is prepared from the following components:

| | |
|---|---|
| Abitol E | 25.00% by weight |
| Dertophene T 105 | 30.00% by weight |
| Evatane 40-55 | 20.00% by weight |
| NMP | 11.11% by weight |
| N-octylpyrrolidone | 5.56% by weight |
| Acetamiprid (99.8%) | 8.33% by weight |

The components are melted at no more than 120° C. in the order stated above and homogenized in a stirred thermocontainer. Using a suitable pump, in this case a gear pump, it is conveyed to the expansion unit. The core of the expansion unit is the mixing station. By means of a two-stage gear pump construction, it is not only possible, in the first stage, to meter the molten adhesive composition, but also, in the second stage, to mix the molten adhesive composition with the gas and then to homogenize the mixture. In a heated pressure tube, the foam thus generated is applied to the web-like support by means of a specifically designed application system. The application system is controlled via a line control system and is capable of coating both the entire area and intermittently. After coating, the web is cooled to a temperature of approximately 7° C., so that it can be further processed to produce individual patches.

1-19. (canceled)

20. An active-substance-comprising patch comprising an expanded, active-substance-comprising matrix with at least one systemic active substance which can be used in plant protection.

21. The patch as claimed in claim 20, characterized in that the active-substance-comprising matrix comprises at least one polymer and/or elastomer, preferably an adhesive composition.

22. The patch as claimed in claim 20, characterized in that the active-substance-comprising matrix comprises an adhesive composition which is a hot-melt adhesive and has a softening temperature of greater than 50° C.

23. The patch as claimed claim 20, characterized in that the active-substance-comprising matrix comprises an adhesive composition which comprises a hot-melt adhesive based on natural and/or synthetic rubbers, ethylene/vinyl acetate copolymers, polyacrylates, polymethacrylates, polyurethanes, polyolefins, polyvinyl derivatives, polyesters or silicones.

24. The patch as claimed in claim 20, characterized in that the active-substance-comprising matrix comprises an adhesive composition which is a hot-melt adhesive from the group of the polymers and copolymers, the polyadducts and the polycondensates.

25. The patch as claimed in claim 20, characterized in that the active-substance-comprising matrix comprises an adhesive composition which comprises a hot-melt adhesive based on an A-B or A-B-A block copolymer, phase A being a polystyrene or a polystyrene derivative and phase B comprising ethylene, propylene, butylene, butadiene or isoprene.

26. The patch as claimed in claim 20, characterized in that the active-substance-comprising matrix has a degree of expansion of 10-75% by volume.

27. The patch as claimed in claim 20, characterized in that the active-substance-comprising matrix has a layer thickness of from 1 mm to 15 cm, preferably from 3 mm to 2 cm.

28. The patch as claimed in claim 20, characterized in that the active-substance-comprising matrix is present in sections which are separate, and capable of being separated, from one another.

29. The patch as claimed in claim 20, characterized in that it features a backing layer and a peelable protective layer.

30. A process for the preparation of an active-substance-comprising patch, comprising the steps: a) preparing an active-substance-comprising melt of at least one polymer and/or elastomer and a systemic active substance which can be used in plant protection, b) introducing gas with expansion of the melt specified under a), c) applying the expanded composition to a support, and d) cooling the expanded composition with formation of an active-substance-comprising expanded matrix.

31. The process as claimed in claim 30, characterized in that step a) is carried out at a temperature above the softening temperature of the polymer or elastomer, preferably at a temperature above 50° C., especially preferably between 70 and 85° C.

32. The process as claimed in claim 30, characterized in that step b) is carried out under elevated pressure, preferably above 100 bar.

33. The process as claimed in claim 30, characterized in that the introduction of gas according to step b) is carried out at a processing temperature which is above the softening temperature of the polymer or elastomer, preferably between 90° C. and 150° C.

34. The process as claimed in claim 30, characterized in that, in step c), the expanded composition is applied to the support in a constant thickness, preferably at a thickness of from 1 mm to 15 cm, especially preferably of between 3 mm and 2 cm.

35. The process as claimed in claim 30, characterized in that step b) is carried out with such an amount of gas that a degree of expansion of between 5 and 85% by volume, preferably of between 10 and 75% by volume, is obtained.

36. The use of a patch as claimed in claim 20 for the application of systemic active substances to plants.

37. The use as claimed in claim 35, characterized in that the plants are trees.

38. The use as claimed in claim 35, characterized in that the application takes place via the trunk or the branches of a tree.
